(19) United States
(12) Patent Application Publication
(10) Pub. No.: US 2026/0300306 A1
(43) Pub. Date: Oct. 1, 2026

(54) Ranking Documents with Respect to a Query Based on Relevance Values

(71) Applicant: Google LLC, Mountain View, CA (US)

(72) Inventors: Himanshu Jain, New York, NY (US); Ziwei Ji, Jersey City, NJ (US); Andreas Veit, New York, NY (US); Sashank Jakkam Reddi, Jersey City, NJ (US); Gayan Sadeep Jayasumana Hirimbura Matara Kankanamge, New York, NY (US); Ankit Singh Rawat, New York, NY (US); Aditya Krishna Menon, New York, NY (US); Xinnan Yu, New York, NY (US); Sanjiv Kumar, Jericho, NY (US)

(21) Appl. No.: 19/479,256

(22) PCT Filed: Apr. 24, 2024
(86) PCT No.: PCT/US2024/026003

§ 371 Date: Oct. 27, 2025

Related U.S. Application Data
(60) Provisional application No. 63/498,696, filed on Apr. 27, 2023.

(51) Int. Cl. G06F 16/2457

(52) U.S. Cl. CPC G06F 16/24578

(57) ABSTRACT

A computer-implemented method includes receiving, by a computing system, a query, computing, by the computing system, a similarity matrix based on a first content associated with the query generated by a first transformer and a second content associated with a plurality of documents generated by a second transformer, processing, by the computing system, the similarity matrix via a neural network to generate relevance values respectively corresponding to the plurality of documents, and ranking, by the computing system, the plurality of documents with respect to the query based on the relevance values.

### PRIORITY CLAIM

The present application is based on and claims priority to U.S. Provisional Application 63/498,696 having a filing date of Apr. 27, 2023, which is incorporated by reference herein.

### FIELD

The disclosure relates to methods and computing systems for information retrieval in response to receiving a query. In particular, the disclosure relates to methods and computing systems for finding and ranking relevant documents from among a large corpus of documents using a machine-learned model in response to receiving a query.

### BACKGROUND

Generally, given a query q E Q the goal of information retrieval is to identify the set of relevant documents for q from some corpus D. Typically, the size of D is large (e.g., millions or even billions), while the number of desired documents is small (e.g., a space complexity of O(10)).

To find the relevant documents, a two-phase approach may be implemented. For example, in the retrieval phase, a predetermined number of documents may be retrieved (e.g., the top-100 or top-1000 documents) based on a scoring function sᵣₑₜ: Q×D→R which models query-document relevance. The retrieved documents may include all (or most) relevant documents, but potentially also some irrelevant documents. Next, in the re-ranking phase, another scoring function sᵣᵣ: Q×D→R may be learned that further re-scores the retrieved documents and keeps a predetermined number of the top scoring ones (e.g., the top-10, top-5, etc.).

While sᵣₑₜ and sir may appear the same, the functions that implement sᵣₑₜ and sᵣᵣ are often very different. For example, sᵣₑₜ may be evaluated over all documents in the corpus; thus, it is desirable for functions implementing sᵣₑₜ to facilitate computationally efficient construction of the retrieved set. Models such as TF-IDF, BM25, and approximate nearest neighbor search may be used for this purpose. On the other hand, in the second phase as a lesser number of documents need to be re-scored (e.g., 100 to 1000), more expensive models can be implemented to calculate sᵣᵣ.

Transformers can be utilized for information retrieval problems, for example, for both the retrieval and re-ranking phase where relevant documents are retrieved and ranked for a given query. Given a finite set X, a transformer is a sequence-to-sequence function T: X^{L}→R^{P×L}, where L is the sequence length and P is the embedding size of each token in the sequence.

Given an input (x₁, . . . , x_{L})), the input may be mapped to X∈R^{P×L} using a dense embedding layer, and then multiple transformer encoding layers may be applied which include softmax attention and position-wise feedforward networks. The final transformer output may be pooled to produce a single vector, e.g., by taking the average of all token embeddings.

To apply such models to query-document relevance, the query and document may be tokenized (e.g., using Word-Piece or SentencePiece tokeniser) into q=(q₁, . . . , q_{L1}) and d=(d₁, . . . , d_{L2}), where typically L₁≠L₂. Two basic strategies may then be implemented according to two families of common transformer-based models: cross-encoder (CE) and dual-encoder (DE) models.

In cross-encoder (CE) models a single transformer may be applied to the concatenation of the query and document tokens, and the similarity may be computed with learned weights w:

$$s ( q , d ) = {w}^{T} pool ( T ( concat ( q , d ) ) ) , \qquad ( 1 )$$

where pool denotes a pooling strategy.

CE models are based on bidirectional encoder representations from transformers (BERT-)style encoders. For example, given a pair of query and document, they are concatenated and sent to a Transformer encoder which outputs a relevance score. CE models allow for cross-interaction between query and document tokens, and hence can learn complex relationships between queries and documents. For example, CE models can potentially consider interactions between the query and document tokens in every transformer layer while computing attention scores.

By contrast, in DE models, separate transformer encoders are applied to the query and document, respectively, and separate query and document embedding vectors are obtained as outputs. The dot product of these two vectors is used as the final relevance score. For example, the similarity may be computed according to:

$$s ( q , d ) = {pool ( {T}_{1} ( q ) )}^{T} pool ( {T}_{2} ( d ) ) . \qquad ( 2 )$$

Since the only interaction between t e query and document occurs in the final dot product, DE models are usually less accurate than CE models. However, DE models have much lower latency than CE models: all the document embedding vectors can be pre-computed offline, and at inference time, the incoming query need only be embedded and the dot products calculated. In practice, CE models tend to outperform DE models for the re-ranking phase. However, CE models can be much more expensive at inference time: the similarity according to equation (1) must be computed for all retrieved documents, and each of them involves an expensive transformer inference. By contrast, with a DE model, the pool(T2(d)) can be computed offline. During inference, only pool(T1(q)) needs to be computed online and a cheap dot-product operation is applied for each document.

Recently, late-interaction models have provided alternatives with a more favorable latency-quality trade-off compared to CE and DE models. Similar to DE models, late-interaction models also use a two-transformer structure, but they store more information and use additional nonlinear score reductions to calculate the final score. In particular, when Q∈R^{P×L1} and D∈R^{P×L2} denotes the query and document token embeddings output by the two transformers respectively, there are L1 query embedding vectors and L2 document embedding vectors of dimension P. DE models simply pool Q and D into two vectors and take the dot product; by contrast, the ColBERT model calculates the (token-wise) similarity matrix Q^{T}D and applies a sum-max reduction to it Σᵢ maxⱼ(Q^{T}D)_{i,j}.

While the sum-max score reduction lets ColBERT model achieve better accuracy than the DE model, it is still a relatively simple non-linear function and might not be able to capture complex query-document interactions, which may be required to assess their true relevance. Moreover, the ColBERT model needs to store the full matrix D for each document which requires non-trivial storage space since L can be large (e.g., a space complexity of O(10²)). For example, the accuracy of the ColBERT model deteriorates significantly with tight storage constraints.

### SUMMARY

Aspects and advantages of embodiments of the disclosure will be set forth in part in the following description, or can be learned from the description, or can be learned through practice of the embodiments.

One example aspect of the disclosure is directed to a computer-implemented method for ranking documents with respect to a query. The method includes receiving, by a computing system, a query, computing, by the computing system, a similarity matrix based on a first content associated with the query generated by a first transformer and a second content associated with a plurality of documents generated by a second transformer, processing, by the computing system, the similarity matrix via a neural network to generate relevance values respectively corresponding to the plurality of documents, and ranking, by the computing system, the plurality of documents with respect to the query based on the relevance values.

In some implementations, the query includes a plurality of query tokens, and the method further includes passing the plurality of query tokens through the first transformer to generate the first content, and the first content corresponds to a plurality of query embeddings.

In some implementations, the plurality of documents include a plurality of document tokens, the method further comprises passing the plurality of document tokens through the second transformer to generate the second content, and the second content corresponds to a plurality of document embeddings.

In some implementations, the second content is generated prior to the query being received by the computing system.

In some implementations, the method further includes flattening the similarity matrix into a one-dimensional vector and the neural network includes a multi-layer perceptron, and processing, by the computing system, the similarity matrix includes processing the flattened similarity matrix via feedforward multi-layer perceptron layers to generate the relevance values respectively corresponding to the plurality of documents.

In some implementations, the neural network includes a multi-layer perceptron, the similarity matrix comprises a plurality of rows and a plurality of columns, and processing, by the computing system, the similarity matrix includes: processing each of the plurality of rows of the similarity matrix via the multi-layer perceptron layers to generate a first updated similarity matrix comprising a column vector comprising a plurality of columns, processing each of the plurality of columns of the column vector via the multi-layer perceptron layers to generate a second updated similarity matrix, and projecting the second updated similarity matrix to generate a single scalar score corresponding to a relevance value for a document among the plurality of documents.

In some implementations, the method further includes computing, by the computing system, a second similarity matrix based on the first content associated with the query generated by the first transformer and a third content associated with a corpus of documents generated by the second transformer; processing, by the computing system, the second similarity matrix via the neural network to generate relevance values respectively corresponding to the corpus of documents; ranking, by the computing system, the corpus of documents with respect to the query based on the relevance values; and selecting a predetermined number of documents from the corpus of documents based on the ranking of the corpus of documents to obtain the plurality of documents.

In some implementations, the plurality of documents are a subset of a corpus of documents associated with the query.

In some implementations, the plurality of documents include a plurality of document tokens, and the method further includes: passing the plurality of document tokens through the second transformer to generate a plurality of document embeddings; and applying average pooling to the plurality of document embeddings to reduce the plurality of document embeddings to obtain a plurality of averaged document embeddings, and the second content corresponds to the plurality of averaged document embeddings.

In some implementations, the plurality of documents include a plurality of document tokens, and the method further comprises: passing the plurality of document tokens through the second transformer to generate a first plurality of document embeddings having a first token dimension; and reducing the first token dimension via linear projection to obtain a second plurality of document embeddings having a second token dimension, the second token dimension being less than the first token dimension; and the second content corresponds to the second plurality of document embeddings having the second token dimension.

Another example aspect of the disclosure is directed to a computing system for ranking documents with respect to a query. The computing system includes one or more processors; and one or more non-transitory computer-readable media that store instructions that, when executed by the one or more processors, cause the computing system to perform operations, the operations comprising: receiving a query; computing a similarity matrix based on a first content associated with the query generated by a first transformer and a second content associated with a plurality of documents generated by a second transformer; processing the similarity matrix via a neural network to generate relevance values respectively corresponding to the plurality of documents; and ranking the plurality of documents with respect to the query based on the relevance values.

In some implementations, the query includes a plurality of query tokens, the operations further comprise passing the plurality of query tokens through the first transformer to generate the first content, and the first content corresponds to a plurality of query embeddings.

In some implementations, the plurality of documents include a plurality of document tokens, the operations further comprise passing the plurality of document tokens through the second transformer to generate the second content, and the second content corresponds to a plurality of document embeddings.

In some implementations, the second content is generated prior to the query being received by the computing system.

In some implementations, the neural network comprises a multi-layer perceptron, and the operations further include flattening the similarity matrix into a one-dimensional vector, and processing the similarity matrix comprises processing the flattened similarity matrix via feedforward multi-layer perceptron layers to generate the relevance values respectively corresponding to the plurality of documents.

In some implementations, the neural network includes a multi-layer perceptron, the similarity matrix includes a plurality of rows and a plurality of columns, and processing the similarity matrix includes: processing each of the plurality of rows of the similarity matrix via the multi-layer perceptron layers to generate a first updated similarity matrix comprising a column vector comprising a plurality of columns, processing each of the plurality of columns of the column vector via the multi-layer perceptron layers to generate a second updated similarity matrix, and projecting the second updated similarity matrix to generate a single scalar score corresponding to a relevance value for a document among the plurality of documents.

In some implementations, the operations further include: computing a second similarity matrix based on the first content associated with the query generated by the first transformer and a third content associated with a corpus of documents generated by the second transformer; processing the second similarity matrix via the neural network to generate relevance values respectively corresponding to the corpus of documents; ranking the corpus of documents with respect to the query based on the relevance values; and selecting a predetermined number of documents from the corpus of documents based on the ranking of the corpus of documents to obtain the plurality of documents.

In some implementations, the plurality of documents include a plurality of document tokens, and the operations further include: passing the plurality of document tokens through the second transformer to generate a plurality of document embeddings; and applying average pooling to the plurality of document embeddings to reduce the plurality of document embeddings to obtain a plurality of averaged document embeddings, and the second content corresponds to the plurality of averaged document embeddings.

In some implementations, the plurality of documents include a plurality of document tokens, and the operations further include: passing the plurality of document tokens through the second transformer to generate a first plurality of document embeddings having a first token dimension; and reducing the first token dimension via linear projection to obtain a second plurality of document embeddings having a second token dimension, the second token dimension being less than the first token dimension; and the second content corresponds to the second plurality of document embeddings having the second token dimension.

Another example aspect of the disclosure is directed to a computer-readable medium (e.g., a non-transitory computer-readable medium) for ranking documents with respect to a query. The non-transitory computer-readable medium stores instructions that are executable by one or more processors of a computing device, the instructions causing the one or more processors to perform operations, the operations comprising: receiving a query; computing a similarity matrix based on a first content associated with the query generated by a first transformer and a second content associated with a plurality of documents generated by a second transformer; processing the similarity matrix via a neural network to generate relevance values respectively corresponding to the plurality of documents; and ranking the plurality of documents with respect to the query based on the relevance values.

In some implementations the computer-readable medium stores instructions which may include instructions to cause the one or more processors to perform one or more operations of any of the methods described herein (e.g., operations of the computing system). The computer-readable medium may store additional instructions to execute other aspects of the computing system and corresponding methods of operation, as described herein.

These and other features, aspects, and advantages of various embodiments of the disclosure will become better understood with reference to the following description and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended drawings, in which:

FIG. 1 depicts a block diagram of an example model for performing various tasks relating to information retrieval and information recommendation tasks, according to example embodiments of the disclosure.

FIG. 2A depicts a block diagram of an example computing system that performs various tasks using a machine-learned model, according to example embodiments of the disclosure.

FIG. 2B depicts a block diagram of an example computing device that performs various tasks using a machine-learned model, according to example embodiments of the disclosure.

FIG. 2C depicts a block diagram of an example computing device that performs various tasks using a machine-learned model, according to example embodiments of the disclosure.

FIGS. 3-5 depict flow chart diagrams of example methods for ranking documents, according to example embodiments of the disclosure.

FIGS. 6-8 depict experimental results obtained according to various methods for ranking documents, according to example embodiments of the disclosure.

Reference numerals that are repeated across plural drawings are intended to identify the same features in various implementations.

### DETAILED DESCRIPTION

### Overview

Reference now will be made to embodiments of the disclosure, one or more examples of which are illustrated in the drawings, wherein like reference characters across drawings are intended to denote like features in various implementations. Each example is provided by way of explanation of the disclosure and is not intended to limit the disclosure.

As explained above, Cross-Encoder (CE) and Dual-Encoder (DE) models are two models for query-document relevance in information retrieval. To predict relevance, CE models use powerful joint query-document embeddings, which comes at the expense of large computation. To address this issue, DE models maintain factorized query and document embeddings, making them computationally efficient, albeit usually at the cost of model quality. Recently, late-interaction models have been proposed to realize more favorable operating points on the latency versus quality trade-off, by using a dual-encoder structure followed by a lightweight model based on query and document token embeddings. However, these lightweight models are often hand-crafted and, furthermore, there is no theoretical understanding of their approximation power. According to aspects of this disclosure, one or more learnable late-interaction models (referred to as lightweight scoring with token einsum or “LITE” models) are described which are universal approximators of continuous scoring functions even under restriction of embedding dimensions.

According to examples of the disclosure, the disclosed LITE models apply a thin non-linear transformation on top of transformer encoders, which corresponds to processing the (token-wise) similarity matrix QTD via a neural network (e.g., shallow multi-layer perceptron (MLP) layers). The disclosed LITE models may be implemented in various ways. For example, in a first implementation, a flattened LITE applies MLP layers to the vectorization of the similarity matrix and in a second implementation a separable LITE applies two-shared MLPs to the rows and the columns of the similarity matrix (in that order) and then projects the resulting matrix to a single scalar score. Both flattened LITE and separable LITE models are universal approximators of continuous scoring functions in l₂ distance. Second, a continuous ground-truth scoring function is constructed that cannot be approximated by a DE model with restricted embedding dimension.

Empirically, via extensive experimentation on MS MARCO and Natural Questions (datasets including a set of search queries and corresponding passages of text from the Internet), the disclosed LITE models can systematically improve upon methods such as ColBERT, particularly in settings with a tight storage budget for document token embeddings. Further, the disclosed LITE models also systematically outperform ColBERT on a wide range of benchmarks including benchmarking-IR (BEIR) zero-shot transfer tasks. Finally, similarly to DE models and other late-interaction methods, the disclosed LITE models are significantly faster than CE models.

According to examples disclosed herein, example LITE models may include first and second transformers and a neural network. For example, a query (e.g., image data, text data, natural language data, combinations thereof, and the like) may be received by the LITE model as an input and one or more documents (e.g., one or more search results) may be provided by the LITE model as an output. The one or more documents (e.g., one or more search results) may be determined by the LITE model as the most relevant documents from among a corpus of documents or from among a plurality of documents. In determining the most relevant documents responsive to the query, the LITE model may search through a plurality of documents, for example, by retrieving and searching documents which are related to or are relevant to the query. The LITE model may determine the most relevant documents through a ranking process described herein. The relevant documents may be provided for display by a computing system in response to the query.

For example, the LITE model may compute a similarity matrix based on a first content associated with the query generated by the first transformer and a second content associated with a plurality of documents generated by the second transformer.

For example, the first transformer may receive the query and process the query. The query may include a plurality of query tokens which may include words or terms that make up the query. The plurality of query tokens may be generated or obtained via one or more tokenization methods (e.g., via Wordpiece, Sentencepiece, etc.) which break down words from the query into smaller units. The plurality of query tokens may be passed through the first transformer to generate the first content. For example, the first content may correspond to a plurality of query embeddings. For example, the query embeddings may correspond to vector representations of the plurality of query tokens that capture their semantic and contextual meaning and may be generated by mapping each query token to a vector of numerical values that captures its semantic meaning and context. For example, the query embeddings may be represented by Q in computing the similarity matrix as S≐Q^{T}D∈R^{L1×L2}.

For example, the second transformer may receive a plurality of documents and process the documents. The documents may include a plurality of document tokens which may include words or terms that make up the documents. The plurality of document tokens may be generated or obtained via one or more tokenization methods (e.g., via Wordpiece, Sentencepiece, etc.) which break down words from a document into smaller units. The plurality of document tokens may be passed through the second transformer to generate the second content. For example, the second content may correspond to a plurality of document embeddings. For example, the document embeddings may correspond to vector representations of the plurality of document tokens that capture their semantic and contextual meaning and may be generated by mapping each document token to a vector of numerical values that captures its semantic meaning and context. For example, the document embeddings may be represented by D in computing the similarity matrix as S≐Q^{T}D∈R^{L1×L2}.

In some implementations, the second content is generated prior to the query being received by the LITE model. For example, the document embeddings may be precomputed offline such that at inference time (e.g., when the query is received by the LITE model) only the query embeddings need to be computed.

In some implementations, the LITE model may reduce a total embedding size to further improve the performance of the LITE model. For example, the LITE model may be configured to reduce the number of document tokens L₂ by passing each of the plurality of document tokens through the second transformer to generate a plurality of document embeddings and then apply average pooling to the plurality of document embeddings to reduce the plurality of document embeddings to obtain a plurality of averaged document embeddings. For example, the second content may correspond to the plurality of averaged document embeddings.

In some implementations, the LITE model may reduce the total embedding size to further improve the performance of the LITE model by another method. For example, the LITE model may be configured to reduce the individual token dimension P by passing the plurality of document tokens through the second transformer to generate a first plurality of document embeddings having a first token dimension and reducing the first token dimension via linear projection to obtain a second plurality of document embeddings having a second token dimension, the second token dimension being less than the first token dimension. For example, the second content may correspond to the second plurality of document embeddings having the second token dimension.

In some implementations, the LITE model may reduce the total embedding size to further improve the performance of the LITE model by a combination of methods. For example, the LITE model may be configured to reduce the number of document tokens L₂ and to reduce the individual token dimension P according to the methods discussed above. For example, the second content may correspond to the second plurality of document embeddings having the plurality of averaged document embeddings and the second token dimension.

The LITE model may be configured to process the similarity matrix via a neural network (e.g., multi-layer perceptron layers (MLPs)) to generate relevance values respectively corresponding to the plurality of documents. For example, the disclosed LITE models apply MLPs to reduce the similarity matrix S to a relevance or scalar value (score). The similarity matrix S may be transformed by the LITE model to the relevance value according to various methods. For example, the similarity matrix S may be transformed by the LITE model via a flattened LITE model or via a separable LITE model which are described in more detail below.

The LITE model may be configured to rank the plurality of documents with respect to the query based on the relevance values. For example, the LITE model may provide an output of a predetermined number of documents which are determined to be most relevant to a computing device which transmitted the query. For example, the LITE model may provide the top 10, top 100, top 1000, etc. search results.

The disclosure provides numerous technical effects and benefits. Results show that the LITE models described herein outperform prior works with respect to ranking documents given a query. Therefore, accuracy is improved compared to previous methods and models.

Current methods such as the ColBERT models apply simple score reductions such as sum-max, and it is unclear if these operations can capture complex interactions among query and document tokens that defines the true relevance. Furthermore, the performance gains realized by such models (compared to DE models) come at the cost of a significant increase in storage requirement. Unlike DE models that store a P-dimensional vector per document, ColBERT models incur L₂ times larger storage cost by requiring to store D∈R^{P×L2}. This increased cost can make ColBERT models prohibitively expensive. As described herein, the LITE models can provably approximate a broad class of ground truth scoring functions and are amenable to reduction of storage cost for document embeddings with graceful degradation in model performance. Therefore, the use of computing resources (e.g., storage) is conserved or reduced.

Latency can also be reduced according to the LITE models disclosed herein compared to CE models. The LITE models disclosed herein have slight increases in latency compared to DE models, while achieving better accuracy.

In summary, the LITE models disclosed herein can: 1) significantly improve accuracy over existing DE models and late-interaction methods, especially under a tight budget on storing document token embeddings; 2) consistently outperform ColBERT models on zero-shot evaluation; and 3) significantly reduce the latency compared with CE models, similarly to DE models and other late-interaction models.

With reference now to the drawings, example embodiments of the disclosure will be discussed in further detail.

### Example Devices and Systems

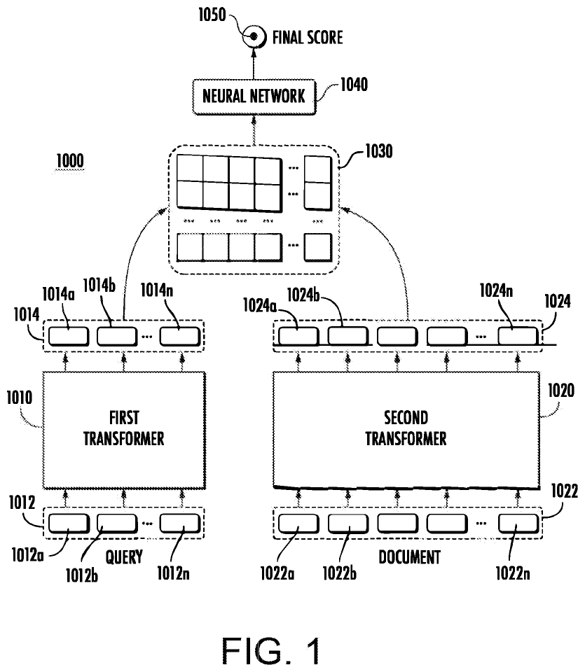

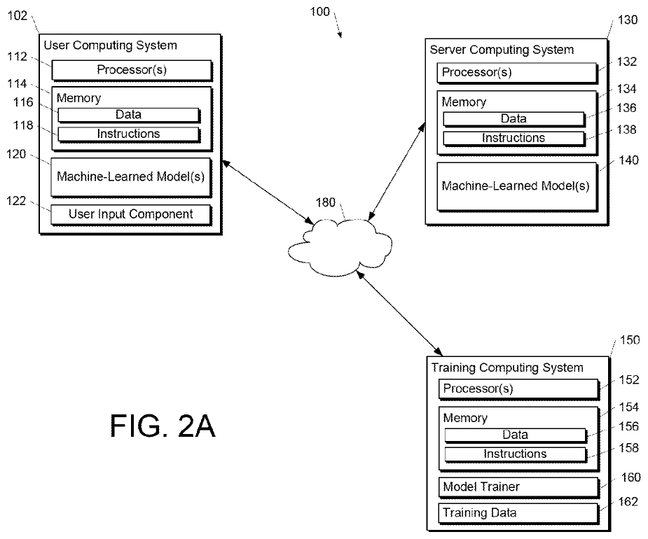

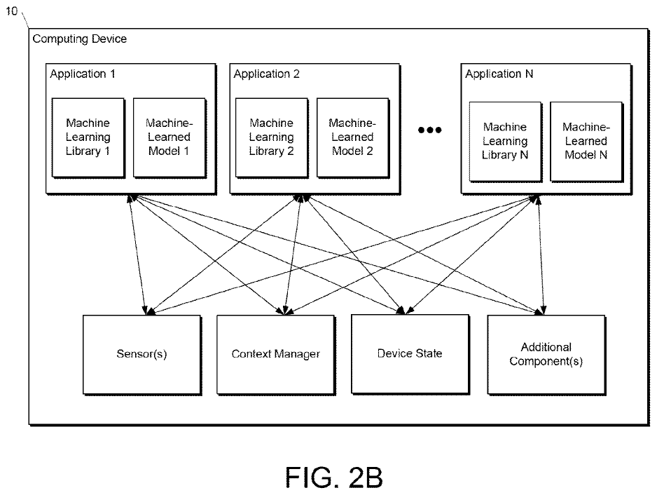

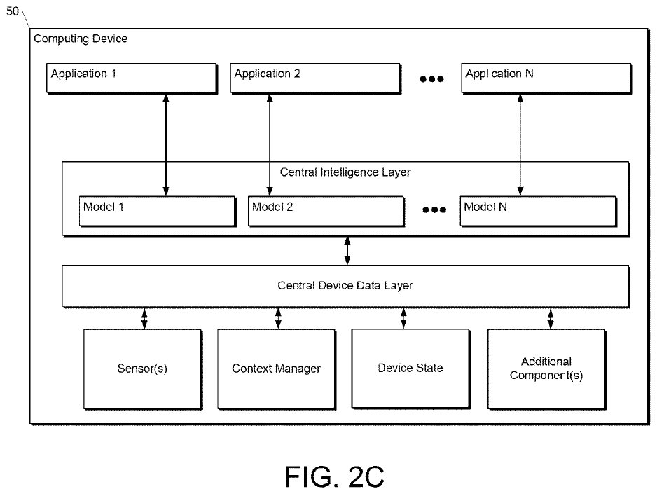

FIG. 1 illustrates an example model for performing various tasks relating to information retrieval and information recommendation tasks, according to example embodiments of the disclosure. In FIG. 1, the model 1000 includes a first transformer 1010, a second transformer 1020, and a neural network 1040. For example, the model 1000 may be implemented by the computing system 100 depicted FIG. 2A including by any of user computing system 102, server computing system 130, or training computing system 150. For example, model 1000 may be stored as one or more of the machine-learned models 120, 140, and/or 160. Below, model 1000 is referred to generally as the LITE model 1000.

Referring back to FIG. 1, the first transformer 1010 may be configured to receive a query 1012. For example, the query 1012 can include image data, text data, natural language data, combinations thereof, and the like. The query 1012 may include a plurality of query tokens 1012a, 1012b . . . 1012n which may include words or terms that make up the query 1012. The plurality of query tokens 1012a, 1012b . . . 1012n may be passed through the first transformer 1010 to generate first content 1014. For example, the first content 1014 may correspond to a plurality of query embeddings 1014a, 1014b . . . 1014n. For example, the plurality of query embeddings 1014a, 1014b . . . 1014n may correspond to vector representations of the plurality of query tokens 1012a, 1012b . . . 1012n that capture their semantic and contextual meaning and may be generated by mapping each query token to a vector of numerical values that captures its semantic meaning and context. For example, the plurality of query embeddings 1014a, 1014b . . . 1014n may be represented by Q in computing the similarity matrix 1030 as S≐Q^{T}D∈R^{L1×L2}.

For example, the second transformer 1020 may receive a document 1022 among a plurality of documents and process the document 1022. The document 1022 may include a plurality of document tokens 1022a, 1022b . . . 1022n which may include words or terms that make up the document 1022. The plurality of document tokens 1022a, 1022b . . . 1022n may be passed through the second transformer 1020 to generate second content 1024. For example, the second content 1024 may correspond to a plurality of document embeddings 1024a, 1024b . . . 1024n. For example, the plurality of document embeddings 1024a, 1024b . . . 1024n may correspond to vector representations of the plurality of document tokens 1022a, 1022b . . . 1022n that capture their semantic and contextual meaning and may be generated by mapping each document token to a vector of numerical values that captures its semantic meaning and context. For example, the plurality of document embeddings 1024a, 1024b . . . 1024n may be represented by D in computing the similarity matrix 1030 as S≐Q^{T}D∈R^{L1×L2}.

In some implementations, the second content 1024 is generated prior to the query 1012 being received by the LITE model 1000 (e.g., by first transformer 1010). For example, the plurality of document embeddings 1024a, 1024b . . . 1024n may be precomputed offline such that at inference time (e.g., when the query is received) only the plurality of query embeddings 1014a, 1014b . . . 1014n need to be computed.

In some implementations, the LITE model 1000 may be configured to reduce a total embedding size to further improve the performance of the LITE model 1000. For example, the LITE model 1000 may be configured to reduce the number of document tokens L₂ by passing each of the plurality of document tokens 1022a, 1022b . . . 1022n through the second transformer 1020 to generate a plurality of document embeddings 1024a, 1024b . . . 1024n and then apply average pooling to the plurality of document embeddings 1024a, 1024b . . . 1024n to reduce the plurality of document embeddings 1024a, 1024b . . . 1024n to obtain a plurality of averaged document embeddings. For example, the second content 1024 may correspond to the plurality of averaged document embeddings.

In some implementations, the LITE model 1000 may be configured to reduce the total embedding size to further improve the performance of the LITE model 1000 by another method. For example, the LITE model 1000 may be configured to reduce the individual token dimension P by passing the plurality of document tokens 1022a, 1022b . . . 1022n through the second transformer 1020 to generate a first plurality of document embeddings 1024a, 1024b . . . 1024n having a first token dimension and reducing the first token dimension via linear projection to obtain a second plurality of document embeddings having a second token dimension, the second token dimension being less than the first token dimension. For example, the second content 1024 may correspond to the second plurality of document embeddings having the second token dimension.

In some implementations, the LITE model 1000 may be configured to reduce the total embedding size to further improve the performance of the LITE model 1000 by a combination of methods. For example, the LITE model 1000 may be configured to reduce the number of document tokens L₂ and to reduce the individual token dimension P according to the methods discussed above. For example, the second content 1024 may correspond to the second plurality of document embeddings having the plurality of averaged document embeddings and the second token dimension.

As mentioned above, the similarity matrix 1030 may be represented as S≐Q^{T}D∈R^{L1×L2} which includes dot products of all query-document transformer token embedding pairs.

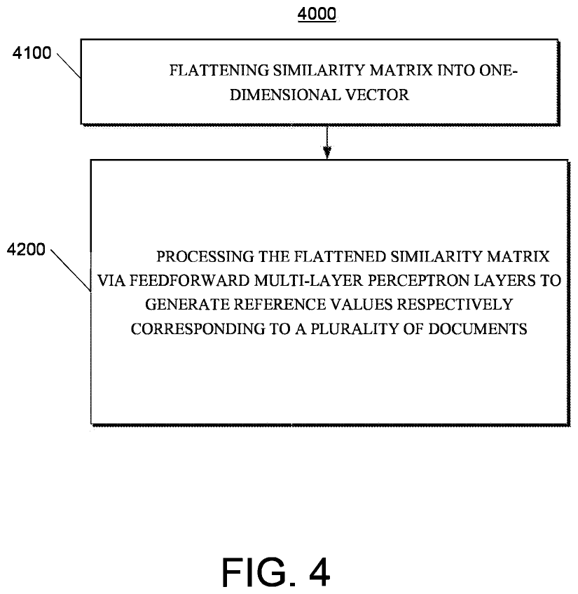

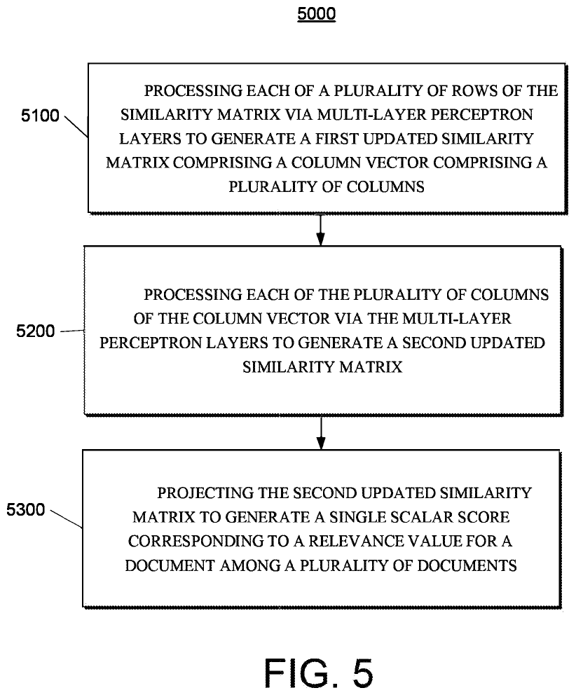

The LITE model 1000 may process the similarity matrix 1030 via a neural network 1040 (e.g., multi-layer perceptron layers (MLPs)) to generate a final score 1050 (relevance score or scalar value) with respect to a document. For example, the disclosed LITE model 1000 may be configured to apply MLPs to reduce S to a relevance score or scalar value. The similarity matrix S may be transformed by the LITE model 1000 to the final score 1050 according to various methods. For example, the similarity matrix S may be transformed via neural network 1040 using a flattened LITE model as described with respect to the method of FIG. 4. For example, the similarity matrix S may be transformed via neural network 1040 using a separable LITE model as described with respect to the method of FIG. 5. The LITE model 1000 may configured to rank a plurality of documents with respect to the query based on the final score 1050 obtained for each respective document. For example, the LITE model 1000 may provide an output of a predetermined number of documents which are determined to be most relevant to a computing device which transmitted the query. For example, the LITE model 1000 may provide the top 10, top 100, top 1000, etc. search results.

In some implementations, the LITE model 1000 may perform the above-discussed operations with respect to a corpus of documents. The corpus of documents may be a large collection of documents (e.g., in electronic form). The LITE model 1000 may be configured to select a predetermined number of documents from the corpus of documents based on the ranking of the corpus of documents to obtain a subset of documents from among the corpus of documents. For example, the top 1000, top 200, top 100, etc., may be selected from the corpus of documents. Then, the LITE model 1000 may be configured to perform the above-discussed operations again with respect to the subset of documents in which case one or more of the documents from among the subset of documents may be re-ranked and the LITE model 1000 can provide an output of the predetermined number of documents from among the re-ranked documents which are determined to be most relevant to a computing device which transmitted the query.

FIG. 2A depicts a block diagram of an example computing system 100 that performs various tasks using a machine-learned model (e.g., a pretrained vision language model or an image aesthetic model) according to example embodiments of the disclosure. The computing system 100 includes a user computing system 102, a server computing system 130, and a training computing system 150 that are communicatively coupled over a network 180.

The user computing system 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120 (e.g., an information retrieval models and/or information recommendation models disclosed herein including the LITE models). For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to the drawings herein.

In some implementations, the one or more machine-learned models 120 can be received from the server computing system 130 over network 180, stored in the memory 114, and then used or otherwise implemented by the one or more processors 112. In some implementations, the user computing system 102 can implement multiple parallel instances of a single machine-learned model 120 (e.g., to perform parallel tasks across multiple instances of the machine-learned model 120).

More particularly, the machine-learned models disclosed herein (e.g., referred to as flattened LITE models, separable LITE models, or generally as LITE models), may be implemented to perform various tasks related to an input query. For example, the machine-learned models disclosed herein may be utilized for retrieving information relating to the query. For example, the machine-learned models disclosed herein may be utilized for ranking the retrieved information relating to the query so that information provided in response to the query is more likely to be relevant to the query and/or so that the amount of information provided in response to the query is limited in some fashion. For example, the machine-learned models disclosed herein may be utilized for providing recommendations or search results relating to a query.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a recommendation service, a search service, an image analysis service, and the like). Thus, one or more machine-learned models 120 can be stored and implemented at the user computing system 102 and/or one or more machine-learned models 140 can be stored and implemented at the server computing system 130.

The user computing system 102 can also include one or more user input components 122 that receives a user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other devices by which a user can provide user input (e.g., a camera which captures an image).

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example machine-learned models 140 are discussed herein with reference to the drawings.

The user computing system 102 and/or the server computing system 130 can train the machine-learned models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing system 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, various datasets which may be stored remotely or at the training computing system 150. For example, in some implementations datasets utilized for training may include the Natural Questions (NQ) dataset, Microsoft MAchine Reading Comprehension (MS MARCO) dataset, T-COVID dataset, NFCorpus dataset, HotpotQA dataset, FiQA-2018 dataset, ArguAna dataset, Touche-2020 dataset, CQAD dataset, Quora dataset, DBPedia dataset, SCIDOCS dataset, FEVER dataset, C-FEVER dataset, SciFact dataset, and the like. However, other datasets may be utilized (e.g., datasets obtained from external websites, etc.).

In some implementations, if the user has provided consent, the training examples can be provided by the user computing system 102. Thus, in such implementations, the machine-learned model 120 provided to the user computing system 102 can be trained by the training computing system 150 on user-specific data received from the user computing system 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the disclosure is a query and/or a plurality of documents. The query and/or documents can include image data, text data, natural language data, combinations thereof, and the like. The machine-learned model(s) can process the query and/or documents to generate an output. As an example, the machine-learned model(s) can process the query and/or documents to determine one or more search results (e.g., from among the documents) relating to the query. As an example, the machine-learned model(s) can process the query and/or documents to rank documents relevant to the query. As an example, the query may include a question and the machine-learned model(s) can process the query and/or documents to output an answer to the question.

FIG. 2A illustrates one example computing system that can be used to implement the disclosure. Other computing systems can be used as well. For example, in some implementations, the user computing system 102 can include the model trainer 160 and the training data 162. In such implementations, the machine-learned models 120 can be both trained and used locally at the user computing system 102. In some of such implementations, the user computing system 102 can implement the model trainer 160 to personalize the machine-learned models 120 based on user-specific data.

FIG. 2B depicts a block diagram of an example computing device 10 that performs according to example embodiments of the disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

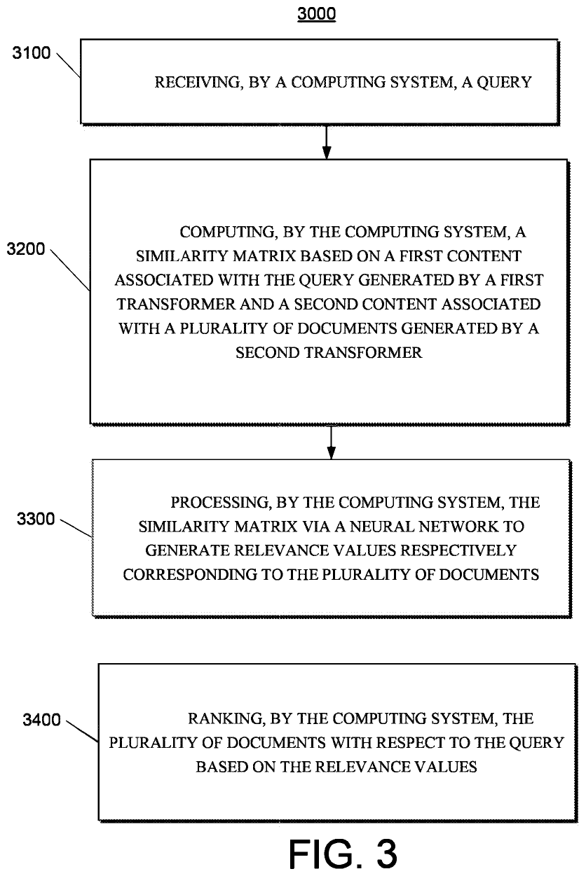

FIG. 3 depicts a flow chart diagram of an example method to perform according to example embodiments of the disclosure. Although FIG. 3 depicts operations performed in a particular order for purposes of illustration and discussion, the methods of the disclosure are not limited to the particularly illustrated order or arrangement. The various operations of the method 3000 can be omitted, rearranged, combined, and/or adapted in various ways without deviating from the scope of the disclosure.

At 3100, a computing system receives a query. For example, the query can include image data, text data, natural language data, combinations thereof, and the like. The query may include text data that is in the form of a question, for example. For example, the query can include a search request or a search query (e.g., via a text input, a voice input, etc.). In determining search results responsive to the query, the computing system may search through a plurality of documents, for example, by retrieving and searching documents which are related to or are relevant to the query. The computing system may determine the most relevant documents through a ranking process described herein with respect to operations 3200, 3300, and 3400. The search results may be provided for display by the computing system in response to the query.

At 3200, the computing system computes a similarity matrix based on a first content associated with the query generated by a first transformer and a second content associated with a plurality of documents generated by a second transformer.

For example, the first transformer may receive the query and process the query. The query may include a plurality of query tokens which may include words or terms that make up the query. The plurality of query tokens may be passed through the first transformer to generate the first content. For example, the first content may correspond to a plurality of query embeddings. For example, the query embeddings may correspond to vector representations of the plurality of query tokens that capture their semantic and contextual meaning and may be generated by mapping each query token to a vector of numerical values that captures its semantic meaning and context. For example, the query embeddings may be represented by Q in computing the similarity matrix as S≐Q^{T}D∈R^{L1×L2}.

For example, the second transformer may receive a plurality of documents and process the documents. The documents may include a plurality of document tokens which may include words or terms that make up the documents. The plurality of document tokens may be passed through the second transformer to generate the second content. For example, the second content may correspond to a plurality of document embeddings. For example, the document embeddings may correspond to vector representations of the plurality of document tokens that capture their semantic and contextual meaning and may be generated by mapping each document token to a vector of numerical values that captures its semantic meaning and context. For example, the document embeddings may be represented by D in computing the similarity matrix as S≐Q^{T}D∈R^{L1×L2}.

In some implementations, the second content is generated prior to the query being received by the computing system. For example, the document embeddings may be precomputed offline such that at inference time (e.g., when the query is received by the computing system) only the query embeddings need to be computed.

In some implementations, the computing system may reduce a total embedding size to further improve the performance of the LITE model. For example, the computing system may be configured to reduce the number of document tokens L₂ by passing each of the plurality of document tokens through the second transformer to generate a plurality of document embeddings and then apply average pooling to the plurality of document embeddings to reduce the plurality of document embeddings to obtain a plurality of averaged document embeddings. For example, the second content may correspond to the plurality of averaged document embeddings.

In some implementations, the computing system may reduce the total embedding size to further improve the performance of the LITE model by another method. For example, the computing system may be configured to reduce the individual token dimension P by passing the plurality of document tokens through the second transformer to generate a first plurality of document embeddings having a first token dimension and reducing the first token dimension via linear projection to obtain a second plurality of document embeddings having a second token dimension, the second token dimension being less than the first token dimension. For example, the second content may correspond to the second plurality of document embeddings having the second token dimension.

In some implementations, the computing system may reduce the total embedding size to further improve the performance of the LITE model by a combination of methods. For example, the computing system may be configured to reduce the number of document tokens L₂ and to reduce the individual token dimension P according to the methods discussed above. For example, the second content may correspond to the second plurality of document embeddings having the plurality of averaged document embeddings and the second token dimension.

At 3300 the computing system processes the similarity matrix via a neural network (e.g., multi-layer perceptron layers (MLPs)) to generate relevance values respectively corresponding to the plurality of documents. For example, the disclosed LITE models apply MLPs to reduce S to a relevance or scalar value (score). The similarity matrix S may be transformed by the computing system to the relevance value according to various methods. For example, the similarity matrix S may be transformed by the computing system via the flattened LITE model as described with respect to the method of FIG. 4. For example, the similarity matrix S may be transformed by the computing system via the separable LITE model as described with respect to the method of FIG. 5.

At 3400 the computing system ranks the plurality of documents with respect to the query based on the relevance values. For example, the computing system may provide an output of a predetermined number of documents which are determined to be most relevant to a computing device which transmitted the query. For example, the computing system may provide the top 10, top 100, top 1000, etc. search results.

In some implementations, the computing system may perform the operations of FIG. 3 with respect to a corpus of documents. The corpus of documents may be a large collection of documents (e.g., in electronic form). The method of FIG. 3 may be performed with respect to the corpus of documents to select a predetermined number of documents from the corpus of documents based on the ranking of the corpus of documents to obtain a subset of documents from among the corpus of documents. For example, the top 1000, top 200, top 100, etc., may be selected from the corpus of documents. Then, the method of FIG. 3 may be performed again with respect to the subset of documents in which case one or more of the documents from among the subset of documents may be re-ranked.

FIG. 4 depicts a flow chart diagram of an example method to perform according to example embodiments of the disclosure. Although FIG. 4 depicts operations performed in a particular order for purposes of illustration and discussion, the methods of the disclosure are not limited to the particularly illustrated order or arrangement. The various operations of the method 4000 can be omitted, rearranged, combined, and/or adapted in various ways without deviating from the scope of the disclosure.

As mentioned previously, the similarity matrix S may be transformed by the computing system via the flattened LITE model. FIG. 4 illustrates operations for flattening the LITE model and obtaining a relevance score via the flattened LITE model.

At 4100, the computing system may flatten the similarity matrix computed at operation 3300 of FIG. 3 into a one-dimensional vector (e.g., by converting the 2D similarity matrix into a 1D array by concatenating its rows or columns).

The similarity matrix may be processed by a neural network which includes a multi-layer perceptron. At 4200, the computing system may process the flattened similarity matrix via feedforward multi-layer perceptron layers to generate the relevance values respectively corresponding to the plurality of documents. For example, the similarity matrix may be transformed into a lower-dimensional representation by passing it through one or more hidden layers of neurons that apply linear transformations and non-linear activation functions (e.g., a sigmoid and/or rectified linear unit function (ReLU)). For example, the feedforward network may be represented as FF(z)=LN(σ(W₂LN(σ(W₁z+b1))+b2)), where LN denotes layer normalization, σ denotes the activation function (e.g., ReLU), W₁ and W₂ are weight matrices, b₁ and b₂ are bias vectors, and z is the input vector. For example, the scoring function may be represented as s(q, d)=w^{T}FF(vec(S)) where q represents the query, d represents a document, S is the similarity matrix between the query and the document, vec(S) is a flattened vector representation of S, w is a weight vector, and FF denotes the feedforward neural network with layer normalization and activation function (e.g., ReLU).

FIG. 5 depicts a flow chart diagram of an example method to perform according to example embodiments of the disclosure. Although FIG. 5 depicts operations performed in a particular order for purposes of illustration and discussion, the methods of the disclosure are not limited to the particularly illustrated order or arrangement. The various operations of the method 5000 can be omitted, rearranged, combined, and/or adapted in various ways without deviating from the scope of the disclosure.

As mentioned previously, the similarity matrix S may be transformed by the computing system via the separable LITE model. FIG. 5 illustrates operations for generating the separable LITE model and obtaining a relevance score via the separable LITE model. For example, the separable LITE model may be generated by applying row-wise updates to the similarity matrix S, then column-wise updates, and then a linear projection to get a scalar score.

The similarity matrix may be processed by a neural network which includes a multi-layer perceptron. At 5100, the computing system may process each of the plurality of rows of the similarity matrix via the multi-layer perceptron layers to generate a first updated similarity matrix comprising a column vector comprising a plurality of columns. For example, the first updated similarity matrix may be represented as S′_{i,:}=LN(σ(W₂LN(σ(W₁S_{i,:}+b₁))+b₂)).

At 5200, the computing system may process each of the plurality of columns of the column vector via the multi-layer perceptron layers to generate a second updated similarity matrix. For example, the second updated similarity matrix may be represented as S″_{:,j}=LN(σ(W₄LN(σ(W₃S′_{:,j}+b₃))+b₄)).

At 5300, the computing system may project the second updated similarity matrix to generate a single scalar score corresponding to a relevance value for a document among the plurality of documents. For example, the scalar score may be determined according to s(q, d)=w^{T}vec(S″) where q represents the query, d represents a document, S is the similarity matrix between the query and the document, vec(S″) is a vector representation of S″, and w is a weight vector. The resulting scalar value represents the overall similarity between the query and the document.

### Experimental Results

The disclosed LITE models were implemented under various conditions and compared with results achieved by other existing models.

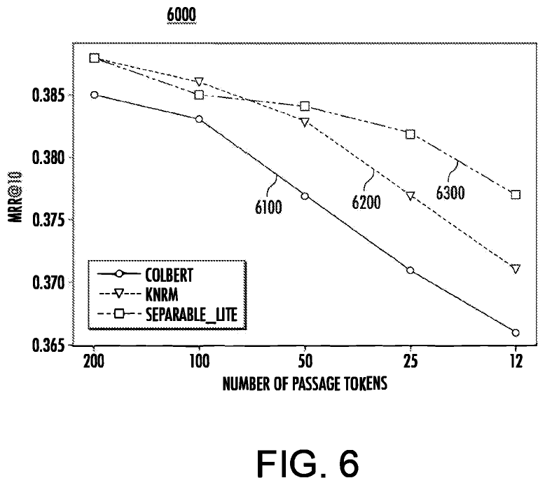

FIGS. 6-8 depict experimental results obtained according to various methods for ranking documents, according to example embodiments of the disclosure. In FIGS. 6-8, the metric used to evaluate the effectiveness of the ranking algorithm and/or recommendation computing system is MRR@10 which stands for “Mean Reciprocal Rank at 10”. MRR@10 measures the quality of the ranked recommendations by computing the reciprocal of the rank position of the first relevant item in the top 10 recommendations. For example, if the first relevant item appears in the 5th position in the list of top 10 recommendations, then the reciprocal of 5, which is 0.2, corresponds to the MRR@10 score for that query. If the first relevant item is not present in the top 10 recommendations, then the MRR@10 score for that query is 0. MRR@10 may be calculated by taking the average of the reciprocal ranks for all queries in a dataset. A higher MRR@10 score indicates that the recommendation computing system or ranking model is more effective at providing relevant recommendations.

FIG. 6 depicts experimental results obtained by applying average pooling to the second transformer which receives the plurality of documents while holding the final token embedding size (P) times the number of passage tokens (L₂) held fixed. In the example of FIG. 6, the final token embedding size (P) is held fixed at 768. In FIG. 6, the chart 6000 shows various results obtained by varying the number of document passage tokens for the ColBERT model 6100, K-NRM model 6200, and the separable LITE model 6300. As reflected in FIG. 6, the separable LITE model 6300 generally achieves better results (e.g., a higher MRR@10 metric indicating that the ranking model is more effective at providing relevant recommendations to users) than the ColBERT model 6100 and the K-NRM model 6200. That is, the ColBERT model 6100 and K-NRM model 6200 rely on relatively long sequences to achieve better accuracy while the separable LITE model 6300 can still achieve good accuracy when the number of passage tokens (L₂) is aggressively reduced.

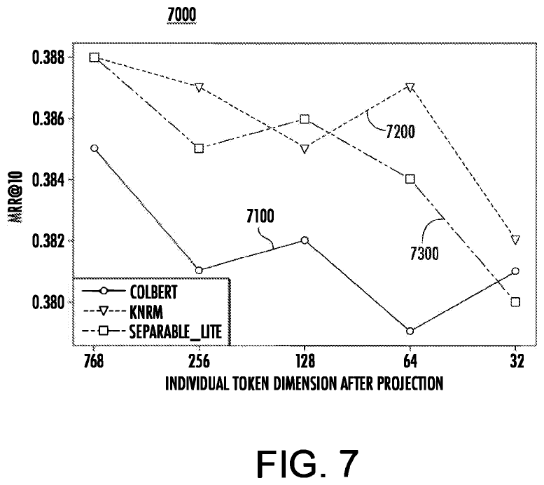

FIG. 7 depicts experimental results obtained by reducing individual token dimensions via learnable linear projection. In the example of FIG. 7, the number of passage tokens (L₂) is held fixed at 200 and the individual token dimension P is reduced via learnable linear projection. In FIG. 7, the chart 7000 shows various results obtained by varying the size of the document token dimension for the ColBERT model 7100, K-NRM model 7200, and the separable LITE model 7300. As reflected in FIG. 7, the overall MRR@10 scores drop slightly as P is reduced. The separable LITE model 7300 generally achieves better results (e.g., a higher MRR@10 metric indicating that the ranking model is more effective at providing relevant recommendations to users) than the ColBERT model 7100 and achieves better results than the K-NRM model 7200 for at least one token dimension value.

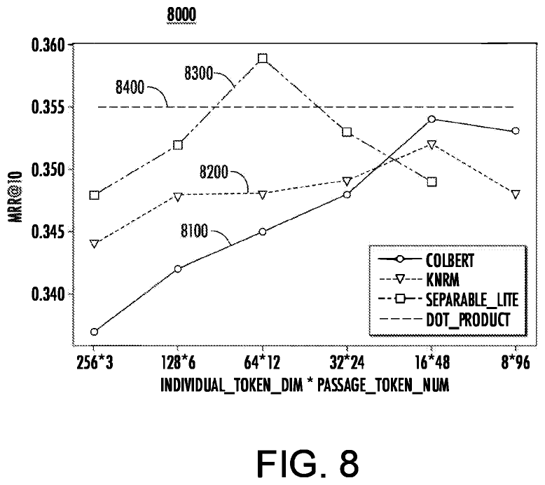

FIG. 8 depicts experimental results obtained by applying both learnable linear projection and average pooling while holding the final token embedding size (P) times the number of passage tokens (L₂) held fixed. In the example of FIG. 8, the final token embedding size (P) times the number of passage tokens (L₂) is held fixed at 768. In FIG. 8, the chart 8000 shows various results obtained by varying the size of the document token dimension and the number of document passage tokens for the ColBERT model 8100, K-NRM model 8200, the separable LITE model 8300, and the DE model baseline 8400. As reflected in FIG. 8, the separable LITE model 8300 can achieve better results (e.g., a higher MRR@10 metric indicating that the ranking model is more effective at providing relevant recommendations to users) than the ColBERT model 8100, K-NRM model 8200, and the DE model baseline 8400.

### Additional Disclosure

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

It will be understood that when an element is referred to as being “connected” to another element, the expression encompasses an example of a direct connection or direct coupling, as well as a connection or coupling with one or more other elements interposed therebetween.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the subject matter as would be readily apparent to one of ordinary skill in the art. For instance, features illustrated or described as part of one embodiment can be used with another embodiment to yield a still further embodiment. Thus, it is intended that the disclosure cover such alterations, variations, and equivalents.

What is claimed is:

1. A computer-implemented method, comprising:
receiving, by a computing system, a query;
computing, by the computing system, a similarity matrix based on a first content associated with the query generated by a first transformer and a second content associated with a plurality of documents generated by a second transformer;
processing, by the computing system, the similarity matrix via a neural network to generate relevance values respectively corresponding to the plurality of documents; and
ranking, by the computing system, the plurality of documents with respect to the query based on the relevance values.

2. The computer-implemented method of claim 1, wherein
the query includes a plurality of query tokens,
the method further comprises passing the plurality of query tokens through the first transformer to generate the first content, and
the first content corresponds to a plurality of query embeddings.

3. The computer-implemented method of claim 2, wherein
the plurality of documents include a plurality of document tokens,
the method further comprises passing the plurality of document tokens through the second transformer to generate the second content, and
the second content corresponds to a plurality of document embeddings.

4. The computer-implemented method of claim 3, wherein the second content is generated prior to the query being received by the computing system.

5. The computer-implemented method of claim 1, further comprising flattening the similarity matrix into a one-dimensional vector, and
wherein
the neural network comprises a multi-layer perceptron, and
processing, by the computing system, the similarity matrix comprises processing the flattened similarity matrix via feedforward multi-layer perceptron layers to generate the relevance values respectively corresponding to the plurality of documents.

6. The computer-implemented method of claim 1, wherein
the neural network comprises a multi-layer perceptron,
the similarity matrix comprises a plurality of rows and a plurality of columns, and
processing, by the computing system, the similarity matrix comprises:
processing each of the plurality of rows of the similarity matrix via layers of the multi-layer perceptron to generate a first updated similarity matrix comprising a column vector comprising a plurality of columns,
processing each of the plurality of columns of the column vector via the layers of the multi-layer perceptron to generate a second updated similarity matrix, and
projecting the second updated similarity matrix to generate a single scalar score corresponding to a relevance value for a document among the plurality of documents.

7. The computer-implemented method of claim 1, further comprising:
computing, by the computing system, a second similarity matrix based on the first content associated with the query generated by the first transformer and a third content associated with a corpus of documents generated by the second transformer;
processing, by the computing system, the second similarity matrix via the neural network to generate relevance values respectively corresponding to the corpus of documents;
ranking, by the computing system, the corpus of documents with respect to the query based on the relevance values; and
selecting a predetermined number of documents from the corpus of documents based on the ranking of the corpus of documents to obtain the plurality of documents.

8. The computer-implemented method of claim 1, wherein the plurality of documents are a subset of a corpus of documents associated with the query.

9. The computer-implemented method of claim 1, wherein
the plurality of documents include a plurality of document tokens, and the method further comprises:
passing the plurality of document tokens through the second transformer to generate a plurality of document embeddings; and
applying average pooling to the plurality of document embeddings to reduce the plurality of document embeddings to obtain a plurality of averaged document embeddings, and
the second content corresponds to the plurality of averaged document embeddings.

10. The computer-implemented method of claim 1, wherein
the plurality of documents include a plurality of document tokens, and the method further comprises:
passing the plurality of document tokens through the second transformer to generate a first plurality of document embeddings having a first token dimension; and
reducing the first token dimension via linear projection to obtain a second plurality of document embeddings having a second token dimension, the second token dimension being less than the first token dimension; and
the second content corresponds to the second plurality of document embeddings having the second token dimension.

11. A computing system, comprising:
one or more processors; and
one or more non-transitory computer-readable media that store instructions that, when executed by the one or more processors, cause the computing system to perform operations, the operations comprising:
receiving a query;
computing a similarity matrix based on a first content associated with the query generated by a first transformer and a second content associated with a plurality of documents generated by a second transformer;
processing the similarity matrix via a neural network to generate relevance values respectively corresponding to the plurality of documents; and
ranking the plurality of documents with respect to the query based on the relevance values.

12. The computing system of claim 11, wherein
the query includes a plurality of query tokens,
the operations further comprise passing the plurality of query tokens through the first transformer to generate the first content, and
the first content corresponds to a plurality of query embeddings.

13. The computing system of claim 12, wherein
the plurality of documents include a plurality of document tokens,
the operations further comprise passing the plurality of document tokens through the second transformer to generate the second content, and
the second content corresponds to a plurality of document embeddings.

14. The computing system of claim 13, wherein the second content is generated prior to the query being received by the computing system.

15. The computing system of claim 11, wherein
the neural network comprises a multi-layer perceptron,
the operations further comprise flattening the similarity matrix into a one-dimensional vector, and
processing the similarity matrix comprises processing the flattened similarity matrix via feedforward multi-layer perceptron layers to generate the relevance values respectively corresponding to the plurality of documents.

16. The computing system of claim 11, wherein
the neural network comprises a multi-layer perceptron,
the similarity matrix comprises a plurality of rows and a plurality of columns, and
processing the similarity matrix comprises:
processing each of the plurality of rows of the similarity matrix via layers of the multi-layer perceptron to generate a first updated similarity matrix comprising a column vector comprising a plurality of columns,
processing each of the plurality of columns of the column vector via the layers of the multi-layer perceptron to generate a second updated similarity matrix, and
projecting the second updated similarity matrix to generate a single scalar score corresponding to a relevance value for a document among the plurality of documents.

17. The computing system of claim 11, wherein the operations further comprise:
computing a second similarity matrix based on the first content associated with the query generated by the first transformer and a third content associated with a corpus of documents generated by the second transformer;
processing the second similarity matrix via the neural network to generate relevance values respectively corresponding to the corpus of documents;
ranking the corpus of documents with respect to the query based on the relevance values; and
selecting a predetermined number of documents from the corpus of documents based on the ranking of the corpus of documents to obtain the plurality of documents.

18. The computing system of claim 11, wherein
the plurality of documents include a plurality of document tokens, and the operations further comprise:
passing the plurality of document tokens through the second transformer to generate a plurality of document embeddings; and
applying average pooling to the plurality of document embeddings to reduce the plurality of document embeddings to obtain a plurality of averaged document embeddings, and
the second content corresponds to the plurality of averaged document embeddings.

19. The computing system of claim 11, the plurality of documents include a plurality of document tokens, and the operations further comprise:
passing the plurality of document tokens through the second transformer to generate a first plurality of document embeddings having a first token dimension; and
reducing the first token dimension via linear projection to obtain a second plurality of document embeddings having a second token dimension, the second token dimension being less than the first token dimension; and
the second content corresponds to the second plurality of document embeddings having the second token dimension.

20. A non-transitory computer-readable medium which stores instructions that are executable by one or more processors of a mobile computing device, the instructions causing the one or more processors to perform operations, the operations comprising:
receiving a query;
computing a similarity matrix based on a first content associated with the query generated by a first transformer and a second content associated with a plurality of documents generated by a second transformer;
processing the similarity matrix via a neural network to generate relevance values respectively corresponding to the plurality of documents; and
ranking the plurality of documents with respect to the query based on the relevance values.
